(19) United States
(12) Patent Application Publication
(10) Pub. No.: US 2006/0168008 A1
(43) Pub. Date: Jul. 27, 2006

(54) Electronic mail display method

(76) Inventor: Cliff Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/991,366

(22) Filed: Nov. 19, 2004

(51) Int. Cl. G06F 15/16

(52) U.S. Cl. 709/206

(57) ABSTRACT

An electronic mail display method is described. The display method establishes a database for storing a sender list and a plurality of group lists for senders, starts an electronic mail monitoring mode for checking incoming electronic mail, executes an electronic mail filtering process, and displays the existence of the incoming mail in a predetermined manner indicative of the senders of the incoming mail on the basis of the information of incoming mail after finishing the electronic mail filtering process.

### BACKGROUND OF THE INVENTION

1. Field of the Invention

The present invention relates to an electronic mail display method, and more particularly, to an electronic mail display method displaying incoming mail in a predetermined manner indicative of users of electronic mail.

2. Description of Prior Arts

As the technology of computer and network progresses on a daily basis, the digitalized electronic-based communication gradually has replaced the conventional paper-based counterpart. With the service of electronic mail system, people can communicate with others in a more convenient way. However, this convenience brings electronic mail users an increasing amount of mail and a large portion thereof is Spam, or, more seriously, viruses. In this situation, how to effectively display the status of each mail account and in which way to notify users of important incoming mail have already become an important issue.

Conventionally, while users want to view their mail either by logging into websites or directly downloading mail into their own computers (terminals) is the only way to do so, to some extent squandering a lot of time and effort.

Reference is made to FIG. 1, which is of a flow chart illustrating the operation of a conventional electronic mail device (software). The electronic mail device (software) at first checks if there is any mail in the server (S100) and if that is the case downloads all mail from the server to the terminal. Otherwise, the electronic mail device (software) rechecks the server in a predetermined period of time (S102). After downloading mail to the terminal end, the electronic mail device (software) shows the existence of incoming mail with some sort of marks for indication (S104).

However, this conventional device (software) has to transfer packets and receive packets from the network in the course of electronic mail checking and downloading and that is the main reason why the conventional device (software) is not that efficient in time and labor. Additionally, if the device (software) fails to download all mail stored in the terminal at that point (largely because of undesired disconnection between the electronic device and the server), the device can only show the status of mail already downloaded but cannot inform the server that some mail in the same batch still remains on the server, meaning that the is electronic mail device has to re-download the whole batch of mail again the next time it checks for mail stored in the server. Moreover, the conventional device merely downloads all mail from the server, regardless of the difference of sender-receiver relationships and mail accounts, although the device (software) does provide users with some manually implemented personalized favorite settings.

### SUMMARY OF THE INVENTION

It is therefore a primary objective of the present invention to provide an electronic mail display method to notify users of incoming mail on the basis of addresses, titles or the content of the incoming mail, in a predetermined viewable or an audible manner.

In accordance with the claimed invention, the present invention electronic mail display method includes steps of establishing a database for storing a sender list and a plurality of group lists for senders, starting an electronic mail monitoring mode, executing an electronic mail filtering process, and displaying corresponding senders in a predetermined manner after finishing the electronic mail filtering process.

It is an advantage of the present invention that every incoming mail message is sorted with respect to sender's mail address, the mail title and the mail content and then the present invention electronic mail display method notifies the user of the sorted mail in a predetermined audible or viewable manner. In doing so, the user of the present invention electronic mail display method is able to decide whether or not to open the newly incoming mail by hearing the sound or looking at the mark on the software window. The sound or the mark is indicative of the corresponding sender.

### BRIEF DESCRIPTION OF THE DRAWINGS

These and other objectives of the present invention will no doubt become obvious to those of ordinary skill in the art after reading the following detailed description of the preferred embodiment that is illustrated in the various figures and drawings, where:

FIG. 1 is a flow chart illustrating a conventional electronic mail display method;

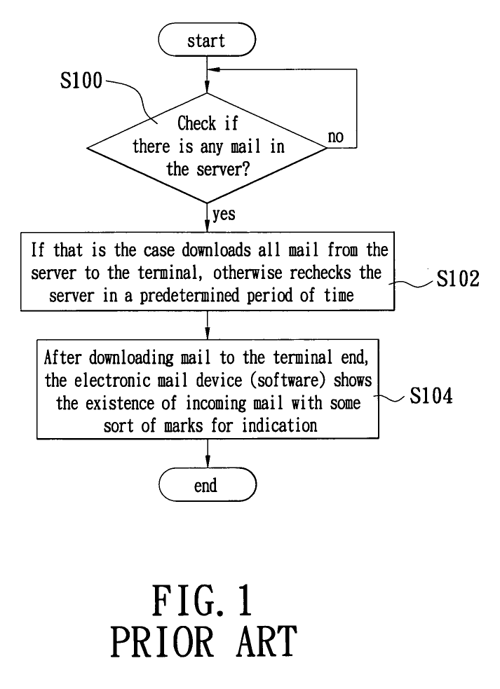

FIG. 2 is a flow chart illustrating an electronic mail display method according to the present invention; and

FIG. 3 is a flow chart of another preferred embodiment according to the present invention.

### DETAILED DESCRIPTION OF THE PREFERRED EMBODIMENT

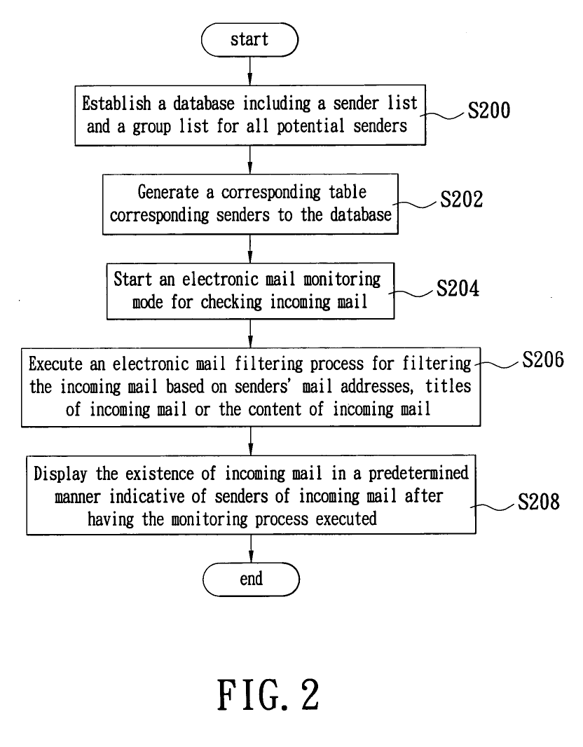

Reference is made to FIG. 2 of a flow chart illustrating steps of the present invention electronic mail display method. The present invention includes steps of establishing a database including a sender list and a group list for all potential senders (S200), generating a corresponding table correlating senders to the database, starting an electronic mail monitoring mode for checking incoming mail (S204), executing an electronic mail filtering process (S206) for filtering the incoming mail based on senders' mail addresses, titles of incoming mail or the content of incoming mail, and displaying the existence of incoming mail in a predetermined manner indicative of senders of incoming mail after having the monitoring process executed (S208). The predetermined manner is a viewable or an audible mode, either of which is configurable as a personalized favorite setting for each different mail sender.

For example, the present invention is applicable to a personal digital assistant (PDA), a desktop or a laptop by establishing a sender list and a plurality of group lists for senders. Thereafter, a corresponding table for all senders and their electronic mail addresses is generated. The corresponding table correlates senders to the established database including the sender list and group lists and each sender is associated with at least one sender group list.

The sender group is configurable as a personalized favorite setting. Users decide their own group lists and who is included in which group. The electronic mail monitoring mode is for checking the status of the server (i.e. existence of incoming mail or not). Once there is any incoming mail message in the server, the present invention executes the electronic mail filtering process for filtering the incoming mail on the basis of the information thereof. The incoming mail information includes the sender's mail address, mail title or the content of the incoming mail. Then, the identification of the sender of the incoming mail is displayed in a predetermined viewable or audible manner. The sound or mark shown on the software window is configurable for each potential sender and users merely rely on the sound or mark to know where the incoming mail comes from.

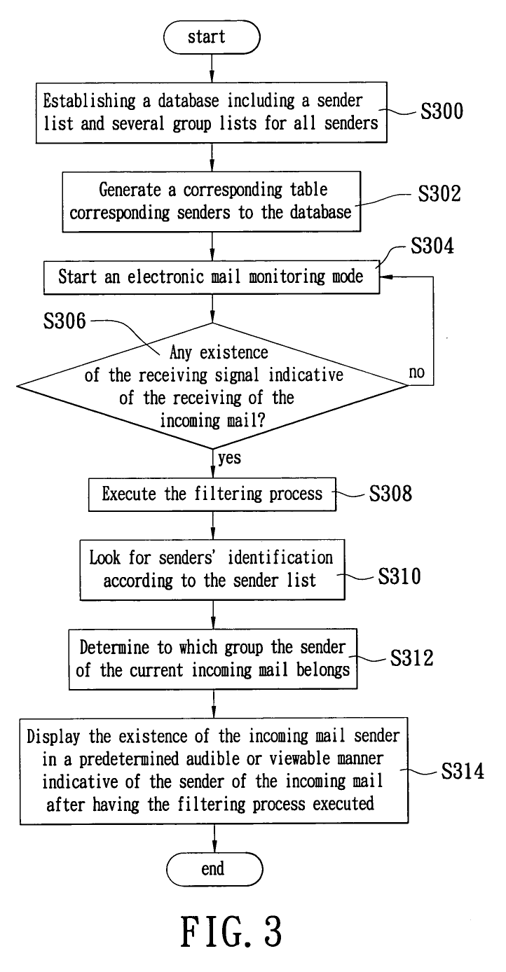

Reference is made to FIG. 3 of a flow chart of another preferred embodiment according to the present invention. The present display method includes steps of establishing a database, including a sender list and several group lists for all senders (S300), generating a corresponding table corresponding senders to the database (S302), and starting a electronic mail monitoring mode (S304) for detecting if there is any receiving signal (S306) indicative of the receiving of the incoming mail. If there is any receiving signal, an electronic mail filtering process is executed, otherwise the present invention method returns to the step of executing the electronic mail monitoring mode. The execution of the filtering process (S308) filters incoming mail with respect to senders' mail addresses, mail titles or the content of incoming mail, looks for senders' identification according to the sender list (S310), and then determines which group the sender of the current incoming mail belongs to (S312). The present invention further includes a step of displaying the existence of the incoming mail sender in a predetermined audible or viewable manner indicative of the sender of the incoming mail after having the filtering process executed (S314).

For example, the present invention establishes the database including the sender list and a plurality of group lists for all senders in electronic devices such as a personal digital assistant (PDA), a desktop or a laptop. Thereafter, a corresponding table for all senders and their electronic mail addresses is generated. The corresponding table correlates senders to the established database including the sender list and group lists and each sender is associated with at least one sender group list.

The sender group is configurable as a personalized favorite setting. Users decide their own group lists and who is included in which group. The electronic mail monitoring mode is for checking the status of the server (i.e. existence of incoming mail or not). Once there is any incoming mail in the server, the present invention executes the electronic mail filtering process for filtering the incoming mail on the basis of the information thereof. The incoming mail information includes the sender's mail address, mail title or the content of the incoming mail. Then the identification of the sender of the incoming mail is displayed in a predetermined viewable or audible manner. The sound or mark shown on the software window is configurable for each potential sender and users merely rely on the sound or mark to know where the incoming mail comes from.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An electronic mail display method, comprising:
establishing a database for storing a sender list and a plurality of group lists for senders;
starting an electronic mail monitoring mode for checking for incoming electronic mail;
executing an electronic mail filtering process; and
displaying existence of the incoming mail in a predetermined manner indicative of senders of the incoming mail based on information about the incoming mail after finishing the electronic mail filtering process.

2. The display method in claim 1, wherein the step of establishing the sender list further includes generates a corresponding table including all electronic mail senders.

3. The display method in claim 2, wherein the corresponding table relates all senders to the database.

4. The display method in claim 1, wherein the electronic mail filtering process is performed based on the information of the incoming mail, including senders' addresses, electronic mail titles, or content of electronic mail.

5. The display method in claim 1, wherein the predetermined manner is a viewable or an audible mode.

6. An electronic mail display method, comprising:
establishing a database for a sender list and a plurality of group lists for senders;
generating a corresponding table for all electronic mail senders;
starting an electronic mail monitoring mode for checking incoming mail;
determining existence of received signals indicative of receipt of incoming mail;
executing an electronic mail filtering process; and
displaying existence of the incoming mail in a predetermined manner indicative of senders of the incoming mail based on the information of incoming mail after finishing the electronic mail filtering process.

7. The display method in claim 6, wherein the corresponding table relates all electronic mail senders to the database.

8. The display method in claim 6, wherein the step of determining the existence of the receiving signals indicative of the receiving of the incoming mail further includes steps of executing the electronic mail filtering process when the receiving signals exist or otherwise returning to starting the electronic mail monitoring process.

9. The display method in claim 6, wherein the information of incoming mail includes senders' mail address, electronic mail titles or content of the incoming mail.

10. The display method in claim 6, wherein the step of executing the electronic mail filtering process further includes steps of looking for senders from the sender list according to senders' mail addresses and thereafter determining to which groups senders belong.

11. The display method in claim 6, wherein the predetermined manner is a viewable or an audible manner.
